(19) United States
(12) Patent Application Publication
(10) Pub. No.: US 2010/0011199 A1
(43) Pub. Date: Jan. 14, 2010

(54) Method and device of bootloader-to-go

(75) Inventors: Huihui Duan, New Bedford, MA (US); Mingming Duan, Spartanburg, SC (US); Chaonan Chen, New Bedford, MA (US)

Correspondence Address: Huihui Duan, Unit #20, 3299 Acushnet Ave, New Bedford, MA, 02745, US

(73) Assignee: Au Group Electronics, New Bedford, MA (US)

(21) Appl. No.: 12/217,637

(22) Filed: Jul. 9, 2008

(51) Int. Cl. G06F 15/177

(52) U.S. Cl. 713/2

(57) ABSTRACT

A method comprising two steps is provided for a simplified on-site bootloading process. Step 1: having a computer or similar device preload initialization instructions and executable codes to an intermediate device. Step 2: having that said device transfer such initialization instructions and executable codes to the operating device. The intermediate device named “bootloader-to-go” is provided in this invention. The said bootloader-to-go device provides the uncomplicated transferring of the initialization instructions and executable codes to the operating device without complex configuration steps. The said bootloader-to-go device is handheld, operated by a single operating switch and is equipped with versatile I/O bus connections compatible to operating devices with various I/O types. There is no need of a hosting computer or similar device on site, the bootloading speed is not controlled by a hosting computer, and therefore the bootloading time is predictable and can be repeated.

### FIELD OF THE INVENTION

This invention relates generally to initialization and loading executable codes of hardware devices. More particularly, the invention relates to an advantageous method for transferring initialization instructions and executable codes to operating devices without a presence of a laptop computer or a network hosting computer in the field. This invention uses a novel speedy and trouble-free method wherein a handheld, error-proof preloaded bootloader-to-go device is capable of transferring initialization instructions and executable codes to operating devices by a single push on an operating switch.

### BACKGROUND

Hardware devices shall be activated with initialization instructions and be loaded with executable codes. For most of embedded systems, nowadays the initialization process is realized through a bootload method and a hosting computer (it can be a networked computer, or an isolated laptop or desktop) that is connected with the operating hardware device. There might be some other converting connectors between the computer and the hard device to match their I/O bus. The initialization instructions and executable codes are stored in non volatile or persistent local or remote peripheral memories or mass storage devices. Common non volatile memory devices are hard disk of the computer, CD, USB storage drive, floppy drive, or network drive. Regardless of what format of such nonvolatile memory device is, the bootloading process needs a computer in presence on site. In some applications where the embedded system is installed in a harsh environment such as below −40 deg C., or in a limited space environment, or lack of AC power outlet, the use of an additional computer is not realistic.

Many bootloaders are configured with various settings. These various settings can be options designed for various operating systems (MAC OS, Windows, Linux, etc), different communication protocols, different I/O ports, different computer device configurations, etc. These configurations can be an added burden to train the in-field installation personnel to choose the settings correctly. Thus, the installation personnel have to be knowledgeable for their hardware device as well as the bootloading system. The complex configured bootloaders often present a risk for erroneous setting selection by the installation personnel leading to a not only longer but also confusing initialization installation process.

Another issue with the lack of standardization of bootloading time is downtime of the hardware device is not predictable. In a multiple-hardware device system, it is an elevated issue due to the unpredictable installation time for each device.

Many embedded systems must boot immediately. However the configuration time and erroneous parameter selection most often post some threat for a fast bootloading process.

For some complex hardware systems, the initialization instructions and executable codes can be very large. Smaller computers, such as a not-well-equipped laptop can take much longer time for bootloading with its limited memory size. Modern laptop computers are less and less equipped with serial communication ports; however serial communication ports are still the most common I/O ports in the embedded control hardware systems and bootload systems. Therefore, the company has to invest more capital to make the computer capable of the predetermined bootloading task.

### SUMMARY OF THE INVENTION

It is therefore one aspect of this invention to provide a method of simplifying the bootloading process to the operating device in the field, ideally without complex configuration selection and even without a need of a computer at the site of bootloading.

It is therefore another aspect of this invention to provide a simple bootload-to-go device which has the portability and a simple operation to transfer bootload initialization instructions and executable codes to the operating device in a predictable and repeatable fashion.

In accordance with these aspects of the invention, a method comprising two steps is provided. Step 1: having a computer or similar device preload initialization instructions and executable codes to an intermediate device. Step 2: having that said device transfer such initialization instructions and executable codes to the operating device.

The key component in this method is the said intermediate device: a device named “bootloader-to-go” in this invention. The said bootloader-to-go device provides the uncomplicated transferring of the initialization instructions and executable codes to the operating device without complex configuration steps. The said bootloader-to-go device is handheld, easy to use with a single operating switch and is equipped with versatile I/O bus connections compatible to various operating devices. There is no need of a hosting computer or similar device on site, the bootloading speed is not controlled by a hosting computer, and therefore the bootloading time is predictable and can be repeated.

Further areas of applicability of the present invention will become apparent from the detailed description provided hereinafter. While the invention is susceptible to various modifications and alternative forms, specific embodiments thereof are shown by way of example in the drawings and are herein described in detail. It should be understood, however, that the drawing are detailed description thereto are not intended to limit the invention to the particular form disclosed, but on the contrary, the intention is to cover all modifications, equivalents and alternatives falling within the spirit and scope of the present invention as defined by the appended claims.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a flow chart embodying the method of the invention: preloading a bootloader-to-go device followed by the bootloading process with the said bootloader-to-go device.

FIG. 2 is a block diagram representing the method of the preloading a bootloader-to-go device remotely in relation to the operating device from a computer or a similar device.

FIG. 3 is a block diagram representing the method of connecting of a bootloader-to-go device with the operating device.

FIG. 4 is a block diagram representing a bootloader-to-go device.

FIG. 5 depicts a hardware design of a bootloader-to-go device.

FIG. 6 illustrates connecting bus between the computer or similar device and the bootloader-to-go device

FIG. 7 illustrates an operating switch circuit in the bootloader-to-go device.

FIG. 8 illustrates an audible component circuit in the bootloader-to-go device.

FIG. 9 illustrates a circuit for visible LED signal in the bootloader-to-go device.

### DETAILED DESCRIPTION OF THE INVENTION

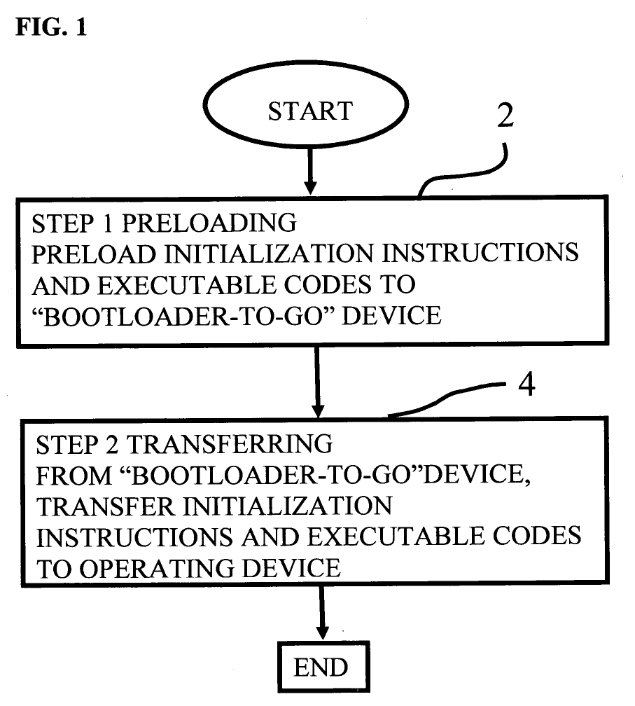

Referring now to the drawings, FIG. 1 illustrates a flow chart embodying the method of the invention. The method comprises two steps. The first step is a step of preloading 2. In various embodiments, the preloading 2 is preloading initialization instructions and executable codes to an intermediate device—the “bootloader-to-go” device 10. In various embodiments, this step may be done remotely from the operating device 16. The second step is a step of transferring 4. It is transferring the initialization instructions and executable codes preloaded in the precedent step 2 to an operating device 16.

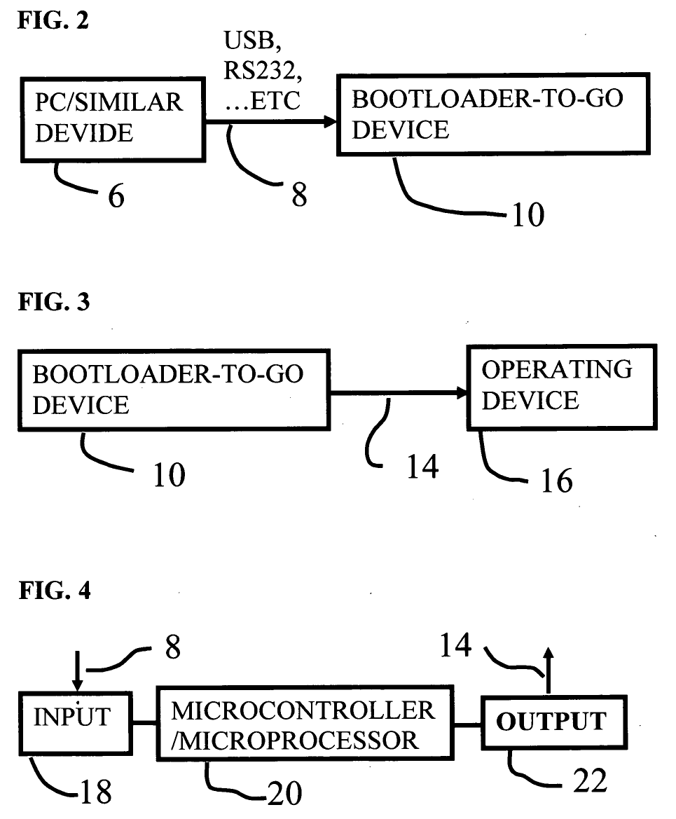

FIG. 2 illustrates a block diagram representing the step of preloading 2, comprising a bootloader-to-go device 10, a PC (personal computer) or a similar device 6, the input bus connection 8 between them. In various embodiments, the bootloader-to-go device may be preloaded by a PC or similar device 6, such as a laptop, or a network computer, or a standalone computer, or a PDA (Personal Digital Assistant), or a cell phone or any other device capable of loading initialization instructions and executable codes to the said bootloader-to-go device 10.

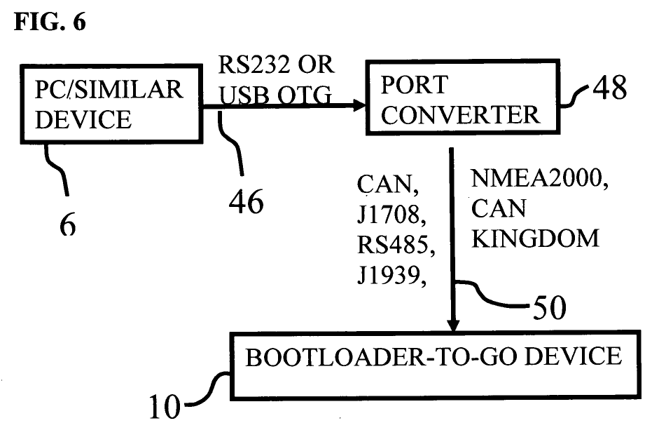

In various embodiments, the input bus connection 8 may be a serial port, such as RS232 interface/protocols, a USB OTG (USB On-The-Go) 46. In various embodiments, the bus connection 8 may be a connection that complies with SAE J1708 protocols (Society of Automotive Engineers J1708 protocols) or RS485 with a port converter 48 between the PC or similar device 6 and the bootloader-to-go device 10, as illustrated in FIG. 6. In various embodiments, the bus connection 8 may include a port converter 48, as illustrated in FIG. 6, where in the connection bus complies with to CAN (Controller Area Network) protocols, such as SAE J1939 protocols; NMEA 2000 (National Marine Electronics Association 2000), CAN Kingdom protocol, etc.

In various embodiments, the said preloaded bootloader-to-go device 10 is rewritable.

FIG. 3 is a block diagram representing the step 4 of transferring the initialization instructions and executable codes from the said bootloader-to-go device 10 to the operating device 16 via an output bus connection 14. In various embodiments, the bootloader-to-go device 10 may be used for multiple operating devices 16, wherein the multiple operating devices 16 may be bootloaded at the same time, or at different times.

In various embodiments, the operating device 16 may be an embedded control system (for example, an electronic control unit for a gasoline engine, or an engine management system for a vehicle, or an industrial furnace temperature controller, etc), a target board, a signal generator/simulator based on embedded control systems; a system operated by a microprocessor.

In various embodiments, the output connection bus 14 from the said bootloader-to-go device 10 to the operating device 16 may comply to USB OTG (USB On-The-Go) protocols, RS232 interface/protocols, SAE J1708 protocols, RS485, CAN (Controller Area Network) protocols, such as J1939 protocols, NMEA 2000 (National Marine Electronics Association 2000) protocols, CAN Kingdom protocol, etc.

FIG. 4 is a block diagram representing a bootloader-to-go device 10. The said bootloader-to-go device 10 comprises a microcontroller or a microprocessor 20, input portion 18 and output portion 22. Through the input portion 18, the bootloader-to-go-device 10 performs the preloading task 2 via various input connections 8; through the output portion 22, the bootloader-to-go-device 10 performs the transferring task 4 via various output connections 14.

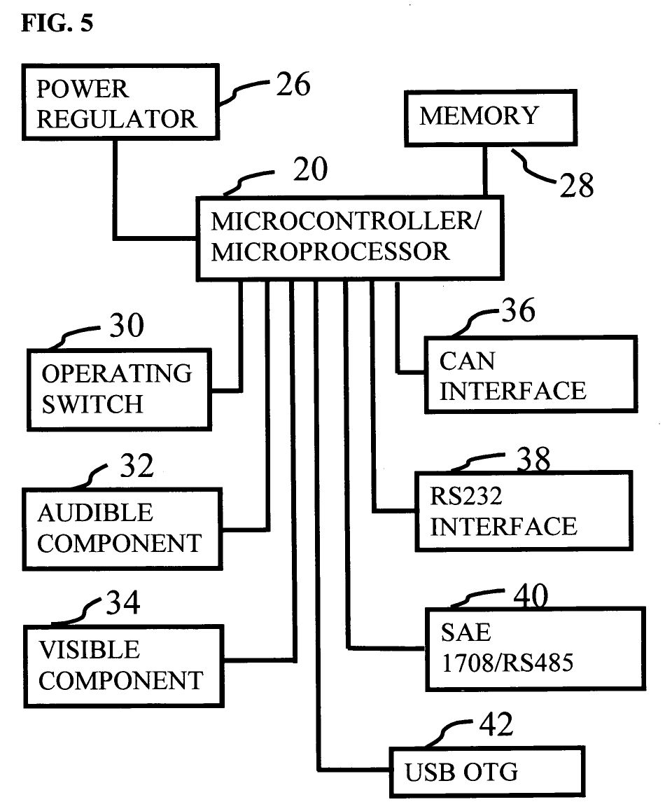

FIG. 5 depicts a hardware design of a bootloader-to-go device 10. The bootloader-to-go device 10 comprises of: a microprocessor or a microcontroller 20, various types of I/O (input/output) bus connections, such as those shown as 36, 38, 40, 42, an operating switch 30, an audible component 32, a visible component 34, memory medium 28 coupled to the microprocessor or microcontroller 20. The said bootloader-to-go device 10 is operated by the said operating switch 30 to transfer the initialization instructions and executable codes from the said bootload-to-go device 10 to the operating device 16, wherein the initialization instructions and executable codes are receivable and executable by the microprocessor or MCU (microcontroller) or DSP (Digital Signal Processor) or DSC (Digital Signal Controller) of the operating device 16 associated with the said bootloader-to-go device 10.

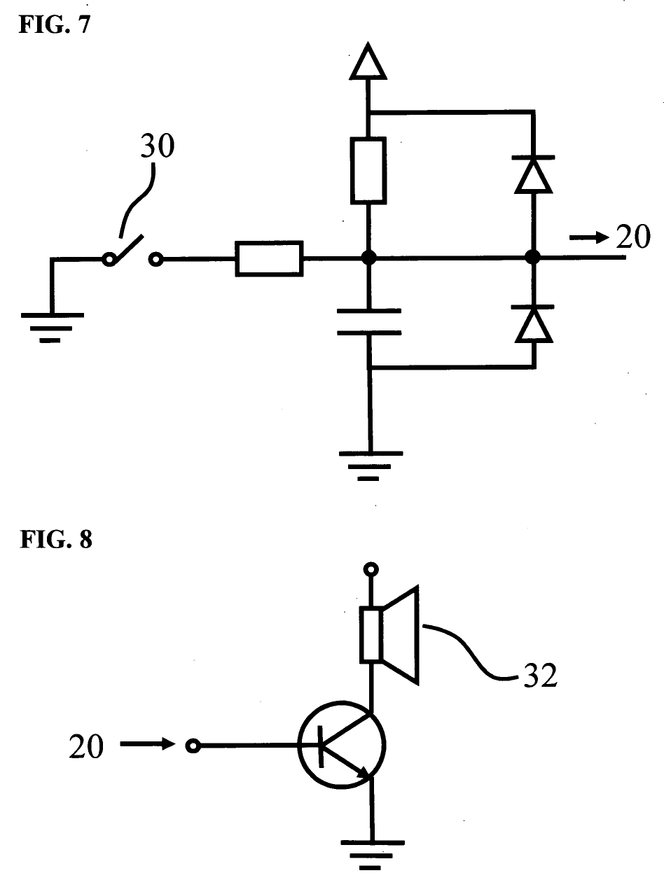

In various embodiments, the memory 28 comprises non-volatile memory (an EEPROM, a flash memory, a battery-backed RAM, etc) and wherein the memory medium stores initialization instructions and executable codes. When the operating switch 30, illustrated in FIG. 7, is activated or turned on, the bootloader-to-go device 10 starts transferring the initialization instructions and executable codes to the operating device 16. When the transferring is completed, the microcontroller/microprocessor 20 of the bootloader-to-go device 10 will generate an audible signal via the audible component 32, and/or generate a visible signal via the visible component 34. Therefore, the bootloading is completed.

In various embodiments, the audible component 32 may be a magnetic buzzer, a speaker, a piezoelectric buzzer, etc. An exemplary hardware circuit is illustrated in FIG. 8. The microcontroller or microprocessor 20 of the bootloader-to-go device 10 controls the signal of the audible component. When such an audible signal is heard, it is an indication that the transferring action 4 has just been completed by the bootloader-to-go device 10 to the operating device 16.

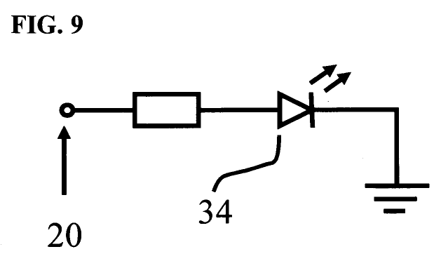

In various embodiments, the visible component 34 may be a LED, a lamp, etc. An exemplary hardware circuit is illustrated in FIG. 9. The microcontroller or microprocessor 20 of the bootloader-to-go device 10 controls the signal of the visible component. When a visible signal is seen, it is an indication that the transferring action 4 has just been completed by the bootloader-to-go device 10 to the operating device 16.

In various embodiments, the bootloader-to-go device 10 may have an audible component 32, or a visible component 34, or both of them.

1. A method for transferring initialization instructions and executable codes to an operating device with a bootloader-to-go device in two steps:
Step 1 preloading: having a computer or similar device preload initialization instructions and executable codes to a bootloader-to-go device via various bus connections.
Step 2 transferring: having that said device transfer such initialization instructions and executable codes to the operating device via various bus connections, wherein the said bootload-to-go device arranged in parallel substantively at the operating device's end.

2. The method of claim 1, wherein the initialization instructions and executable codes for an operating device are loaded remotely with regard to where the operating device is.

3. The method of claim 1, wherein the operating device includes embedded control systems (for example, an electronic control unit for a gasoline engine, or an engine management system for a vehicle, or an industrial furnace temperature controller, etc), a target board, a signal generator/simulator based on embedded control systems; a system operated by a microprocessor.

4. The method of claim 1, wherein the said bootloader-to-go is used for multiple operating devices.

5. The method of claim 1, wherein the bootloader-to-go device is preloaded by a laptop, or a network computer, or a standalone computer, or a PDA (Personal Digital Assistant), or a cell phone or any other device capable of loading initialization instructions and executable codes to the said bootloader-to-go device.

6. A bootloader-to-go device, comprising:
A microprocessor or a microcontroller,
I/O (input/output) bus connections,
An operating switch,
An audible component (a magnetic buzzer, a speaker, a piezoelectric buzzer, etc),
A visible component (such as a LED, or a lamp, etc),
Memory medium coupled to the microprocessor or microcontroller, wherein the memory comprises non-volatile memory (an EEPROM, a flash memory, a battery-backed RAM, etc) and wherein the memory medium stores initialization instructions and executable codes, and
Wherein the said bootloader-to-go device is operated by the said operating switch to transfer the initialization instructions and executable codes from the said bootload-to-go device to the operating device.

7. The device of claim 6, wherein the initialization instructions and executable codes are receivable and executable by the microprocessor or MCU(microcontroller) or DSP (Digital Signal Processor) or DSC (Digital Signal Controller) of the operating device associated with the said bootloader-to-go device; wherein the initialization instructions and executable codes are carried from the said bootloader-to-go device to the operating device by USB OTG (USB On-The-Go) protocols, or RS232 interface/protocols, or SAE J1708 protocols, or RS485, or CAN (Controller Area Network) protocols, such as J1939 protocols, NMEA 2000 (National Marine Electronics Association 2000) protocols, CAN Kingdom protocol, etc.

8. The method of claim 1, wherein in the preloading step, the bus connection between a computer or a similar device to the said bootloader-to-go device is a serial port, such as RS232 interface/protocols, and USB OTG (USB On-The-Go).

9. The method of claim 1, wherein in the preloading step, the bus connection between a computer or a similar device and the said bootloader-to-go device complies with SAE J1708 protocols or RS485 with a port convertor.

10. The method of claim 1, wherein in the preloading step, the bus connection between a computer or a similar device and the said bootloader-to-go device complies with CAN (Controller Area Network) protocols, such as J1939 protocols; NMEA 2000 (National Marine Electronics Association 2000), CAN Kingdom protocol, etc.

11. The device of claim 6, wherein the said preloaded bootloader-to-go device is rewritable.
